(19) United States
(12) Patent Application Publication
(10) Pub. No.: US 2004/0047346 A1
(43) Pub. Date: Mar. 11, 2004

(54) Large telecommunications network

(76) Inventor: James Edward Vandendorpe, Naperville, IL (US)

Correspondence Address: Werner Ulrich, 434 Maple Street, Glen Ellyn, IL, 60137, US

(21) Appl. No.: 10/192,790

(22) Filed: Jul. 10, 2002

(51) Int. Cl. H04L 12/50

(52) U.S. Cl. 370/359; 370/535

(57) ABSTRACT

A method and apparatus implementing a large telecommunications network. A large Channel Group Switch is connected to a plurality of tandem switches and/or end office switches and toll switches. A route consists of all channel groups interconnecting two specific switches via the Channel Group Switch. Connections between a pair of channel groups in the Channel Group Switch are fixed as long as the pair of channel groups are assigned to the same route. The Channel Group Switch connects all traffic on one channel group to a particular other channel group. As traffic demands change, channel groups are assigned to different routes. In one preferred embodiment, the channel groups are DS-1 Groups of 24 channels each, a sufficiently small number to permit routes to be enlarged or decreased for the benefit of other routes. Advantageously, such an arrangement can be used to interconnect a large number of tandem switches efficiently.

### TECHNICAL FILED

This invention relates to the implementation of large telecommunications network.

### Problem

The telecommunications network of the United States is a hierarchical network which includes end offices (class 5) connected to customers by lines; tandem offices, i.e., tandem switches connected to the end offices by trunks; and toll offices connected to both tandem switches and end offices by toll access trunks. In addition, toll switches are interconnected by inter-toll trunks, tandem switches interconnected by inter-tandem trunks, and end offices are interconnected by inter-office trunks. When routing a call from a customer connected to one end office to another customer connected to another end office, the call is routed preferably by a direct inter-office trunk, or if no such trunk is available, to one or more tandems, or for the case of a toll call, through one or more toll switches.

A problem arises in a metropolitan area, such as, for example, the Chicago Area, wherein there is a large amount of traffic among all the end offices of the area. Most of this traffic is carried through a tandem switch, each tandem switch having a limited number of DS-1 trunk appearances, each appearance pre-assigned to a specific route. As the number of tandem switches required to serve the metropolitan area increases, the fixed sizes of the group of trunks interconnecting pairs of tandem switches decreases, and the efficiency of such small trunk groups also decreases. At any given moment, especially during the busy hour, some of these fixed size groups are substantially under-utilized, while others are used beyond their capacity, causing blockage. In the present implementation, a point is reached where the addition of an added tandem switch can actually reduce the traffic capacity of the network, because the size of the trunk groups is reduced each time a new switch is added, and smaller trunk groups are less efficient. The result is that the cost of carrying tandem traffic in such a large metropolitan area becomes high.

### Solution

Applicant has studied this problem, and has concluded that what is needed is an arrangement for interconnecting tandem switches through a large switch, a Channel Group Switch, which by having reduced functions (as compared, for example, to the functions carried out in a toll switch), can perform a massive inter-tandem switching function at low cost. One such switch is the Lamda™ Manager, manufactured until recently by Lucent Technologies Inc. The Lamda Manager, as normally used, is a cross-connect switch used for establishing provisioned connections, over SONET facilities, between switches that are maintained for long periods of time; such a switch has replaced the simple wire cross-connect systems used for interconnecting two-wire analog trunks terminating on tandem switches end offices, or toll switches.

Applicant has further recognized that in order to take full advantage of such a Channel Group Switch, it is necessary for the trunk groups from each tandem switch to the Channel Group Switch to be dynamically adjustable in size as demand changes. Each trunk group is destined for a particular destination, and as traffic demands change, it is highly desirable that the size of the different trunk groups connecting each tandem switch to the Channel Group Switch for each destination be adjustable in size.

Accordingly, with one specific embodiment of Applicant's invention, some, or all of the switches connected to the DS-1 Switch, are arranged to dynamically change the number of channels for different routes. The number of channels can be increased by dedicating additional DS-1 Groups to a particular route; channels can be decreased by consolidating traffic on existing routes to make available a DS-1 Group of Channels for use on a different route.

In accordance with one specific embodiment of Applicant's invention, the Channel Group Switch handles both DS-3 (672 channels), and DS-1 (24 channels) Signals. The Channel Group Switch is arranged to switch DS-1 Signals which are either connected to other switches, or to DS-3/DS-1 Multiplexers for transmission as DS-3 Signals to other switches. Advantageously, the DS-1 signals contain a sufficiently small number of channels so that groups of channels can be added or sub-tracted to particular routes as the needs of traffic require.

### BRIEF DESCRIPTION OF THE DRAWING(S)

FIG. 1 is a block diagram illustrating the configuration of a communications network;

FIG. 2 is a flow diagram illustrating the process of enlarging a traffic route;

FIG. 3 is a flow diagram illustrating the process of consolidating traffic over a route; and

FIG. 4 is a flow diagram illustrating the process of setting up the connection.

### DETAILED DESCRIPTION

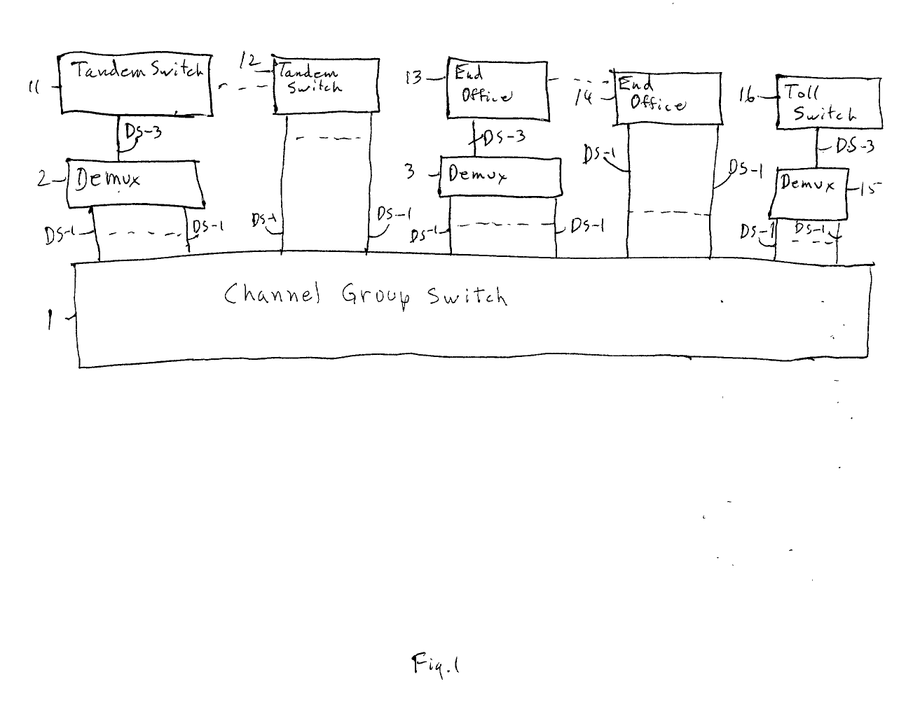

FIG. 1 is a block diagram illustrating a large telecommunications network. Inputs to the network include tandem switches (11) and (12), end offices (13) and (14) and toll switch (16). The tandem switches have inputs from other end offices (not shown), and the toll switch has inputs from other tandem switches or end offices (also not shown). All of the above switches are interconnected by a Channel Group Switch (1), which is a DS-1 switch, i.e., a switch which can switch any DS-1 input signal to any DS-1 output signal. The outputs of tandem switch (11), end office (13), and toll switch (16) are DS-3 Signals. Such signals are passed through a DS-3/1, Demux (2), (3), (15), whose outputs are DS-1 Signals. Tandem switch (12) and end office (14) communicate with Channel Group Switch (1) directly via DS-1 Signals.

A DS-1 Signal carries 24 Voice Channels; a DS-3 Signal carries 28 DS-1 Signals.

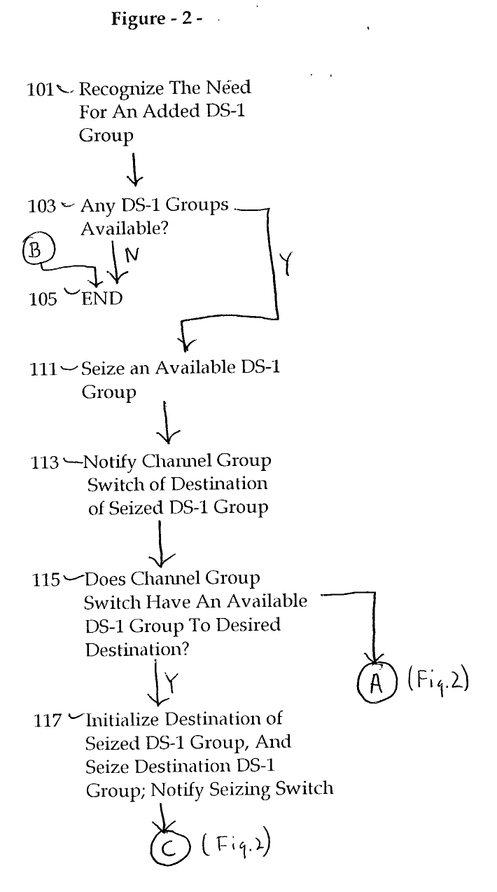

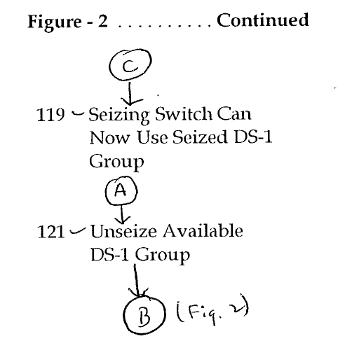

FIG. 2 is a flow diagram illustrating the process of enlarging a route both from, and to, one of the switches connected to the Channel Group Switch (1). In Action Block (101), a need is recognized to add a DS-1 Group. The recognition of this need is based on parameters supplied by a telecommunications operating company. For example, a need may be recognized whenever a group of M DS-1 Groups has fewer than N available channels, where M and N are parameters supplied by the telecommunications company. The need can also be based on dynamic changes such as a reduction in the number of available channels of X percent in less than Y seconds, where X and Y again, are parameters, supplied by a telecommunications operating company; different values of X and Y can be supplied for different numbers of DS-1 Groups of a route.

Once the need for an additional DS-1 Group has been recognized, then Test (103) is used to determine if any DS-1 Groups to the Channel Group Switch are available. If not, this is the end of the process, Action Block (105), and after some timing, Action Block (101) can be re-entered.

If an available DS-1 Group exists, then that group is seized, Action Block (111). The Channel Group Switch is notified of the seizure of that DS-1 Group, and the destination of the seized Group, Action Block (113). In Test (115), the Channel Group Switch, or, alternatively, the destination switch, determines whether it has an available DS-1 Group to the desired destination. If not, the message is sent back to the requesting switch to un-seize the available DS-1 Group, Action Block (121) and End Block (105) is entered.

If the Channel Group Switch has an available DS-1 Group to the desired destination, then Channel Group Switch initializes the destination of the seized DS-1 Group, and seizes an output DS-1 Group to the desired destination; it notifies the seizing switch that it has accepted the seizure of the DS-1 Group, Action Block (117). The seizing switch can now use the seized DS-1 Group for traffic to the desired destination, Action Block (119).

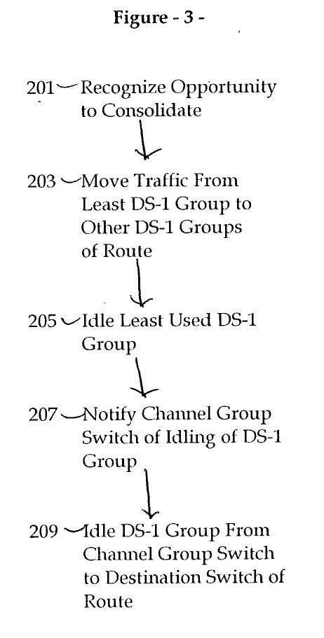

FIG. 3 is a flow diagram illustrating the process of consolidating traffic over a route. In order to allow some DS-1 Groups to become available for carrying new traffic, it is necessary to have a process such that when traffic for a particular route decreases sufficiently, this traffic is consolidated in specific DS-1 Groups in order to remove all traffic from other DS-1 Groups. This is the purpose of the process described in the flow Chart of FIG. 3. First, an opportunity to consolidate traffic to one fewer DS-1 Groups for a particular route is recognized, Action Block (201). The requirement for such recognition is that at least 24 channels are available on that route. In order to avoid shuttling back and forth, the number of available channels should be substantially greater than 24, and can be specified by a table of the number of available channels as a function of the number of DS-1 Groups in a particular route. These parameters would be supplied by a telephone operating administration. Next, traffic is moved from the least used DS-1 Group to other DS-1 Groups of that route, Action Block (203). The process of moving such traffic can be accomplished by routing the traffic temporarily over both the existing path and a path in the DS-1 Group which will handle this traffic after the movement. When this has been accomplished at both ends, then the traffic can be reassigned to the new channel, and the old channel becomes available. Finally, the least used DS-1 Group from which all traffic has been removed is idled and made available for assignment to a new route, Action Block (205), and the Channel Group Switch is informed that this DS-1 Group is now available, and that the destination of that DS-1 Group in the Channel Group Switch can now also be made available, Action Block (207). The DS-1 Group from the Channel Group Switch to the destination switch of the route is also idled, Action Block (209).

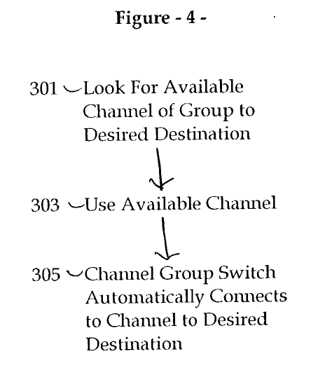

FIG. 4 is a flow diagram illustrating the process of setting up the connection. The originating tandem or toll switch, which has received a request for a connection, looks for an available channel in a DS-1 Group to the desired destination, Action Block (301). To prepare for subsequent overloads, the available channel should be one on the most heavily used DS-1 Group. This available channel is then used for the connection, Action Block (303). The Channel Group Switch has a connection from that available channel to a channel to the desired destination, and the call is set-up over that connection. Action Block (305).

The above description is of one preferred embodiment of Applicant's invention. Other embodiments will be apparent to those of ordinary skill in the art without departing from the scope of the invention. The invention is limited only by the attached Claims.

I claim:

1. In a large telecommunications network, a method of setting up telecommunications connections, comprising the steps of:
connecting a plurality of switches to a Channel Group Switch;
said Channel Group Switch for interconnecting channel groups, each of said channel groups containing a plurality of communications channels;
in each switch connected to said Channel Group Switch, routing all telecommunications calls of a particular route to a disjoint set of channel groups;
in at least some of said plurality of switches, adding channel groups to a route when necessary;
in said at least some of said plurality of switches, consolidating channel groups of a route to reduce the number of channel groups of that route by one, when traffic warrants such reduction; and
notifying said Channel Group Switch whenever a channel group is added to a route or subtracted from a route;
wherein a route represents all traffic from a switch connected to said Channel Group Switch to another switch connected to said Channel Group Switch.

2. The method of claim 1, wherein each of said Channel Groups is a DS-1 Group.

3. The method of claim 1, wherein the step of consolidating channel groups of a route comprises the steps of:
moving traffic from a first DS-1 Group of a route to other DS-1 Groups of that route; and
after having moved all traffic from said first DS-1 Group, idling said first DS-1 Group to make said first DS-1 Group available for traffic of other routes originating or terminating in a switch connected to said first DS-1 Group.

4. The method of claim 1, wherein the step of connecting a plurality of switches comprises the step of connecting at least one tandem switch.

5. The method of claim 1, wherein the step of connecting a plurality of switches comprises the step of connecting at least one toll switch.

6. In a large telecommunications network, apparatus for setting up telecommunications connections, comprising:
a plurality of switches connected to a Channel Group Switch;
said Channel Group Switch for interconnecting channel groups, each of said channel groups containing a plurality of communications channels;
each switch connected to said Channel Group Switch, for routing all telecommunications calls of a particular route to one of a disjoint set of channel groups;
at least some of said plurality of switches for adding channel groups to a route when necessary;
said at least some of said plurality of switches for consolidating channel groups of a route to reduce the number of channel groups of that route by one, when traffic warrants such reduction; and
each of said at least some of said plurality of switches for notifying said Channel Group Switch whenever a channel group is added to a route or subtracted from a route;
wherein a route represents all traffic from a switch connected to said Channel Group Switch to another switch connected to said Channel Group Switch.

7. The apparatus of claim 1, wherein each of said Channel Groups is a DS-1 Group.

8. The apparatus of claim 1, wherein consolidating channel groups of a route comprises:
moving traffic from a first DS-1 Group of a route to other DS-1 Groups of that route; and
after having moved all traffic from said first DS-1 Group, idling said first DS-1 Group to make said first DS-1 Group available for traffic of other routes originating or terminating in a switch connected to said first DS-1 Group.

9. The apparatus of claim 6, wherein said plurality of switches comprises at least one tandem switch.

10. The apparatus of claim 6, wherein said plurality of switches comprises at least one toll switch.
